(19) United States
(12) Patent Application Publication
(10) Pub. No.: US 2009/0013854 A1
(43) Pub. Date: Jan. 15, 2009

(54) System and Method for Indicating Selective Regions of A Musical Instrument

(76) Inventor: Mark Hara, Maitland, FL (US)

Correspondence Address: Robert L. Wolter;Beusse Wolter Sanks Mora & Maire, P.A., Suite 2500, 390 North Orange Avenue, Orlando, FL, 32801, US

(21) Appl. No.: 12/116,460

(22) Filed: May 7, 2008

Related U.S. Application Data
(60) Provisional application No. 60/949,067, filed on Jul. 11, 2007.

(51) Int. Cl. G09B 15/06

(52) U.S. Cl. 84/485 R

(57) ABSTRACT

A system is provided for indicating at least one selective region of a musical instrument. The musical instrument includes a main body portion, and an elongated neck portion extending from the main body portion. The elongated neck portion includes a plurality of spaced-apart boundaries configured to define a plurality of regions along the elongated neck portion. The system includes at least one physical indicator positioned along a back side of the elongated neck portion opposite to a front side, and further along the back side adjacent to at least one of the plurality of regions. The at least one physical indicator is configured to provide non-visual sensory confirmation of the position of the plurality of regions along the elongated neck portion.

### CROSS-REFERENCE TO RELATED APPLICATIONS

This application is based on and claims priority to U.S. Provisional Application No. 60/949,067 filed Jul. 11, 2007.

### FIELD OF THE INVENTION

The present invention relates to musical instruments, and more particularly, to a system and method for indicating one or more selective regions of an elongated neck portion of a musical instrument.

### BACKGROUND OF THE INVENTION

Many modern-day musical instruments, as well as the recent past and even antique musical instruments, include a main body portion and an elongated neck extending from the main body portion. In general, many of such musical instruments include a number of strings extending from the end of the neck of the instrument to an anchor point of the strings on the body portion of the instrument. Typically, the end of the neck portion to which the strings are attached includes a mechanism to separately tighten each string in order to achieve the proper pitch when a string is vibrated. For example, such musical instruments may include a guitar, both electrical and acoustical, a bass guitar, and other like stringed musical instruments.

Once such stringed instruments are properly tuned by appropriately tightening each of the strings, the instrument is ready to be played. Playing the stringed instruments not only consists of causing the strings to vibrate by finger strumming or picking the strings, but also by varying the effective length of the strings. By sliding their hand along the length of the neck of the instrument and pressing the strings between their fingers and the instrument neck, the musician varies the effective length of the strings and thereby changes the pitch of the sound produced by the strings. In either event, the player holds the instrument at the neck end by positioning the elongated neck between their extended fingers and thumb, with their hand bent at the wrist.

Typically, the construction of the elongated neck of conventional musical instruments has a cross-sectional shape having a flat front side and a convexly shaped or outwardly curved back side which somewhat resembles the configuration of a capital letter “D”. A plurality of frets, comprising raised narrow ridges extending along the front side of the elongated neck, and transverse to the neck of the instrument, are spaced from each other along the length of the neck of the instrument. The strings of the instrument are extended over the front side of the neck, over the transverse frets, and are equally spaced over the frets such that they are generally parallel to each other with spaces therebetween. When positioning and playing such a conventional stringed instrument, the player or musician typically positions one hand around the neck with their fingers on the front side with the strings and their thumb against the convexly curved back side. Then, by squeezing the one or more strings and the neck of the instrument between their thumb and one of their extending fingers either at the location of the frets or between the frets, a desired pitch of the instrument is achieved. By varying the location of their hand along the neck of the instrument and squeezing the strings at different locations, different pitches are achieved.

In a conventional guitar, for example, fret regions are marked with a visual markings, both along the front side of the elongated neck and along a top side between the front end and the back end, typically directed upward toward the musician for easy visual observation while playing, for example. In an example of an acoustic guitar, these selectively marked fret regions may include the 1^{st}, 3^{rd}, 5^{th}, 7^{th}, 9^{th}, 12^{th} (2 markings), and 15^{th} fret regions. In an example of an electric guitar, these selectively marked fret regions may include the 1^{st}, 3^{rd}, 5^{th}, 7^{th}, 9^{th}, 12^{th} (2 markings), 15^{th}, and 17^{th}, fret regions.

As such conventional stringed instruments require visual confirmation when the musician repositions their hand between fret regions, these conventional stringed instruments do not accommodate musicians with visual disabilities. Accordingly, it would be advantageous to provide a stringed instrument which provides non-visual sensory confirmation to musicians with visual disabilities upon repositioning their hand between fret regions.

### BRIEF DESCRIPTION OF THE INVENTION

In one embodiment of the present invention, a system is provided for indicating at least one selective region of a musical instrument. The musical instrument includes a main body portion, and an elongated neck portion extending from the main body portion. The musical instrument further includes a plurality of strings extending along a front side of the elongated neck portion from an anchor point positioned adjacent to a first end of the elongated neck portion attached to the main body portion, to a respective plurality of tightening devices positioned at a second end of the elongated neck portion opposite from the first end. The elongated neck portion includes a plurality of spaced-apart boundaries configured to define a plurality of regions along the elongated neck portion. The system includes at least one physical indicator positioned along a back side of the elongated neck portion opposite to the front side, and further along the back side adjacent to at least one of the plurality of regions. The at least one physical indicator is configured to provide non-visual sensory confirmation of the position of the plurality of regions along the elongated neck portion.

In another embodiment of the present invention, a system is provided for indicating at least one selective region of a musical instrument. The musical instrument includes a main body portion, and an elongated neck portion extending from the main body portion. The elongated neck portion includes a plurality of spaced-apart boundaries configured to define a plurality of regions along the elongated neck portion. The system includes at least one physical indicator positioned along the elongated neck portion adjacent to at least one of the plurality of regions. The at least one physical indicator is configured to provide non-visual sensory confirmation of the position of the plurality of regions along the elongated neck portion.

In another embodiment of the present invention, a method is provided for indicating at least one selective region of a musical instrument. The musical instrument includes a main body portion, and an elongated neck portion extending from the main body portion. The musical instrument further includes a plurality of strings extending along a front side of the elongated neck portion from a first end of the elongated neck portion attached to the main body portion to a respective plurality of tightening devices positioned at a second end of the elongated neck portion opposite from the first end. The elongated neck portion includes a plurality of spaced-apart boundaries configured to define a plurality of regions along the elongated neck portion. The method includes positioning at least one physical indicator along a back side of the elongated neck portion opposite to the front side. The method further includes positioning the at least one physical indicator along the back side adjacent to at least one of the plurality of regions. The method further includes providing non-visual sensory confirmation of the position of the plurality of regions along the elongated neck portion.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a front perspective view of an embodiment of a system for indicating selective regions of an elongated neck portion of a musical instrument;

FIG. 2 is a rear perspective view of an embodiment of a system for indicating selective regions of an elongated neck portion of a musical instrument;

FIG. 3 is a cross-sectional view of an embodiment of an elongated neck portion of a musical instrument in accordance with the present invention;

FIG. 4 is a cross-sectional view of an embodiment of an elongated neck portion of a musical instrument in accordance with the present invention;

FIG. 5 is a cross-sectional view of an embodiment of an elongated neck portion of a musical instrument in accordance with the present invention;

FIG. 6 is a front perspective view of an embodiment of a system for indicating selective regions of an elongated neck portion of a musical instrument;

FIG. 7 is a rear perspective view of an embodiment of a system for indicating selective regions of an elongated neck portion of a musical instrument; and

FIG. 8 is a flow chart illustrating an exemplary embodiment of a method for indicating selective regions of an elongated neck portion of a musical instrument.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

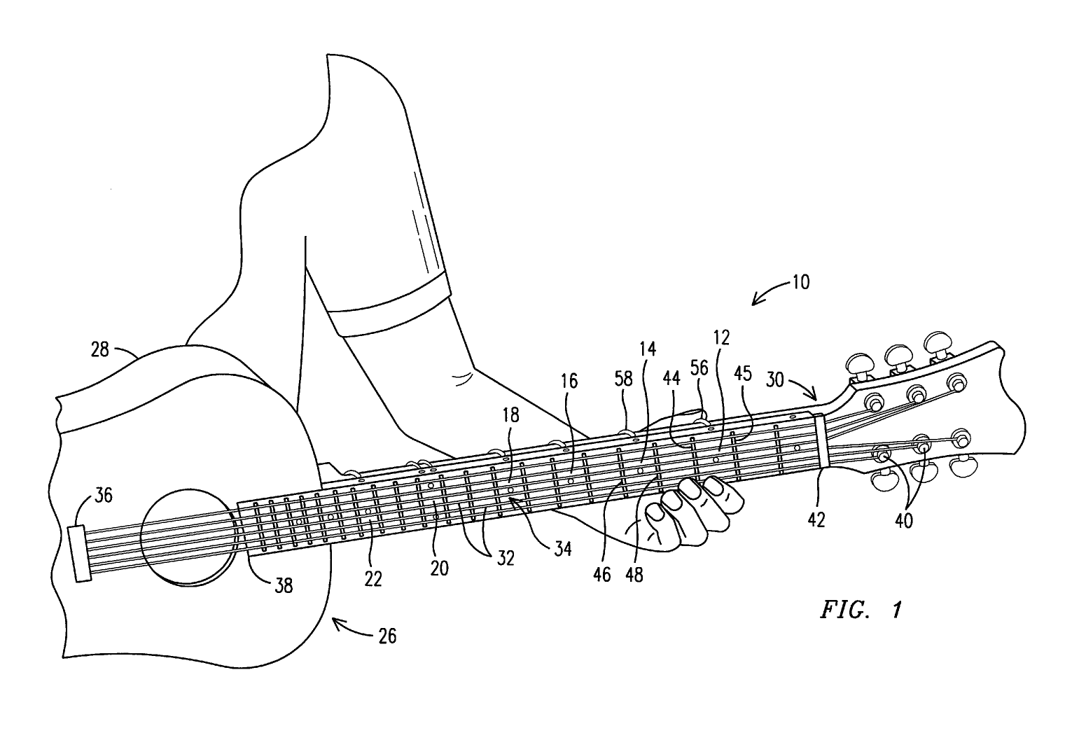

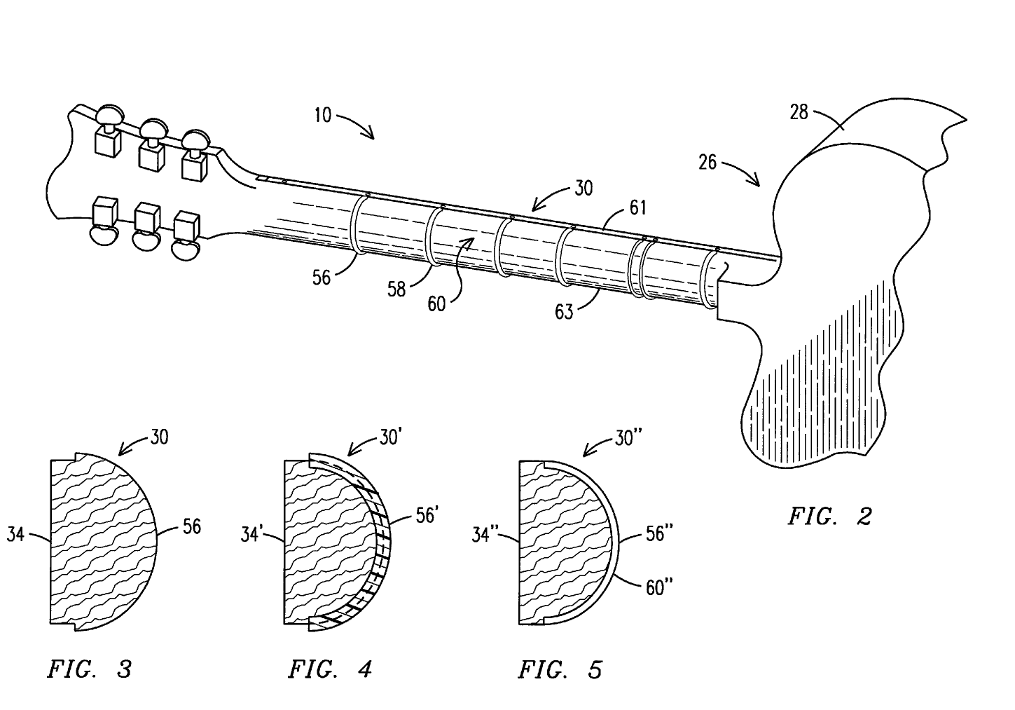

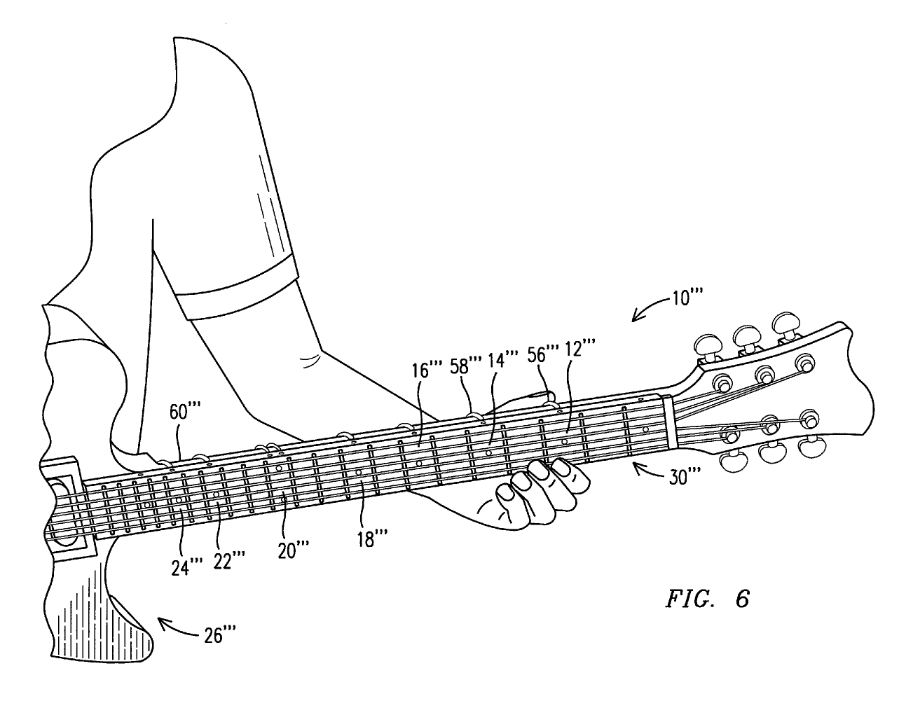

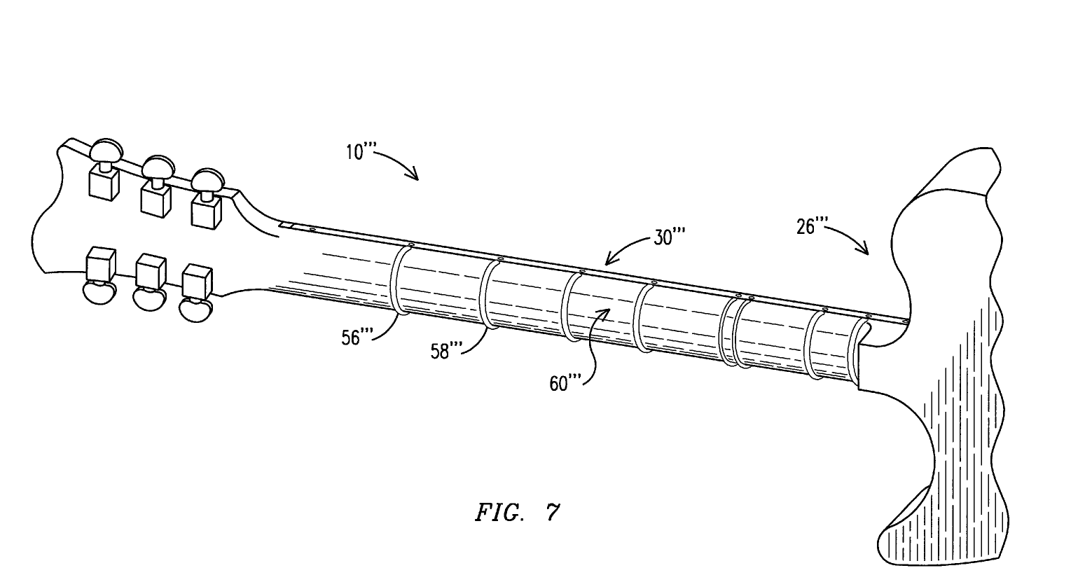

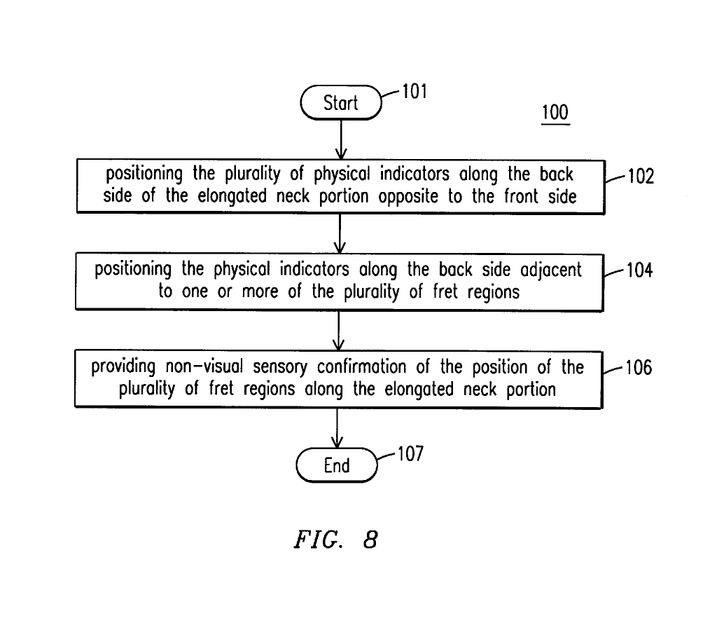

FIG. 1 illustrates a system 10 for indicating one or more selective non-consecutive regions 12, 14, 16, 18, 20, 22 of a musical instrument 26, such as an acoustic guitar, for example. In the illustrated exemplary embodiment of FIGS. 1-2, the selective non-consecutive regions include the 3^{rd}, 5^{th}, 7^{th}, 9^{th}, 12^{th}, and 15^{th} regions, as is appreciated by one of skill in the art. Although the illustrated exemplary embodiments in FIGS. 1-7 of the present invention describe those embodiments as they relate to guitars, the exemplary embodiments of the present invention may be similarly applied to any musical instrument including an elongated neck portion with a plurality of regions through which a plurality of strings extend, as described below. Additionally, although the illustrated exemplary embodiment of FIGS. 1-2 describe those embodiments as they specifically relate to acoustic guitars, and the exemplary embodiments of FIGS. 6-7 describe those embodiments as they relate specifically to electric guitars, the illustrated and described features of acoustic and electric guitars may be common to both or all guitars and included within the scope of the present invention.

The acoustic guitar 26 includes a main body portion 28, an elongated neck portion 30 which extends out from the main body portion 28, and a plurality of strings 32 which extend along a front side 34 of the elongated neck portion 30. As further illustrated in the exemplary embodiment of FIG. 1, the plurality of strings 32 extend from an anchor point 36 where the plurality of strings 32 attach to the main body portion 28, and adjacent to a junction point of a first end 38 of the elongated neck portion 30 and the main body portion 28. The plurality of strings 32 extend along the elongated neck portion 30 to a respective plurality of tightening devices 40 positioned adjacent to a second end 42 of the elongated neck portion 30, opposite to the first end 38.

As illustrated in the exemplary embodiment of FIG. 1, the elongated neck portion 30 includes a plurality of spaced-apart boundaries (44,45), (46,48), or fret boundaries, to respectively define a plurality of regions 12,14, or fret regions, along the elongated neck portion 30. As illustrated in the exemplary embodiments of FIGS. 1-2, the system 10 includes a plurality physical indicators 56,58 positioned adjacent to the respective plurality of fret regions 12,14 respectively defined by the plurality of spaced-apart fret boundaries (44,45), (46,48). For the embodiment illustrated in FIGS. 1-2, and all embodiments of the present invention discussed below, the general description of one or more physical indicators discussed in an embodiment (eg. 56,58 for FIGS. 1-2) is intended to generally describe all of the physical indicators in the respective embodiment. Although FIGS. 1-2 illustrate a physical indicator positioned adjacent to each of the selective non-consecutive fret regions 12, 14, 16, 18, 20 (2 indicators), 22, a physical indicator may be positioned adjacent to every fret region or in a selective non-consecutive fret region arrangement different than that shown in FIGS. 1-2. Although FIGS. 1-2 illustrate more than one physical indicator positioned along the neck portion 30 of the acoustic guitar 26 to indicate a plurality of fret regions, one physical indicator may be utilized to indicate one fret region.

As illustrated in the exemplary embodiment of FIG. 2, each physical indicator 56,58 is configured to extend along a back side 60 of the elongated neck portion 30 opposite to the front side 34. Each physical indicator 56,58 extends along the back side 60 from a top portion 61 to a bottom portion 63 of the back side 60. However, the physical indicators may not completely extend from the top portion to the bottom portion of the back side. Each physical indicator 56,58 provides non-visual sensory confirmation of the placement of a musician's hand adjacent to a respective fret region 12,14 along the elongated neck portion. Although the above discussion and FIG. 2 discusses two particular physical indicators 56,58 for two respective fret regions 12,14, in the exemplary embodiment of FIG. 2 a plurality of physical indicators are selectively placed adjacent to each of the selective non-consecutive fret regions 12,14,16,18,20,22. Additionally, although FIG. 2 illustrates an arrangement in which a plurality of physical indicators are selectively placed adjacent to each of the selective non-consecutive fret regions (i.e. 3^{rd}, 5^{th}, 7^{th}, 9^{th}, 12^{th}, 15^{th} fret regions), one or more physical indicators may be respectively placed adjacent to one or all of the fret regions, for example. Additionally, although FIG. 2 illustrates a plurality of physical indicators positioned adjacent to a single fret region 22 (i.e. 12^{th} fret region), one or more physical indicator may be positioned adjacent to any single fret region. During use of the system 10, a musician with a visual disability who plays the acoustic guitar 26 need not visually confirm when his/her fingers are positioned within or adjacent to the correct fret region. Instead, the musician may utilize non-visual sensory perception with the selective physical indicators when his/her fingers are positioned within or adjacent to the correct selective fret region, and thus play the correct note based on each of the plurality of strings having the correct adjustable length.

Although FIG. 2 illustrates each physical indicator 56,58 extending around the entire rounded surface of the back side 60 of the elongated neck portion 30, the physical indicators may only extend around a portion of the rounded surface of the back side 60 of the elongated neck portion 30. A musician with a visual disability may selectively modify the length of the plurality of strings and thus play the correct note using the tightening devices 40 for the strings 32 in combination with the physical indicators 56,58 to provide a non-visual sensory indication of the location of each fret region 12,14.

FIG. 3 illustrates an exemplary embodiment of a cross-section of the elongated neck portion 30. The cross-sectional shape of the exemplary embodiment of the elongated neck portion 30 may take a “D-shape”, where the front side 34 of the elongated neck portion 30, as discussed above, forms the flat surface of the cross-section, and the back side 60 forms the curved, arcuate surface (FIG. 2). However, the elongated neck portion 30 is not restricted to taking any specific “D” cross-sectional shape, or confined to any one cross-sectional shape. The cross-sectional view of FIG. 3 is taken at the transverse location of the physical indicator 56 along the elongated neck portion 30, and thus in the cross-sectional view, the physical indicator 56 extends beyond the back side 60, forming the curved surface of the elongated neck portion. In the exemplary embodiment of the elongated neck portion 30, as illustrated in FIGS. 1-3, the plurality of physical indicators 56,58 are integrated into the elongated neck portion 30, and thus formed of the same material, as shown in the exemplary cross-sectional view of FIG. 3. In an exemplary embodiment of the present invention, each physical indicator may be ⅛″ wide, and 1/16″ deep, for example. Additionally, in an exemplary embodiment of the present invention, the 2 physical indicators in the 12^{th} fret region may be spaced by a ⅛″ gap, for example. However, the physical indicators may have any width, depth and separation within each respective fret region.

In an additional embodiment of the present invention, as illustrated in FIG. 4, an elongated neck portion 30′ includes a similar “D-shaped” cross-sectional form, as in the embodiment of FIG. 3 above. Unlike the embodiment of the elongated neck portion 30 illustrated in FIG. 3, in which the physical indicator 56 is integrated into the elongated neck portion 30, the elongated neck portion 30′ includes a non-integrated physical indicator 56′ which may be made from a different material than the elongated neck portion 30′ and is affixed to the elongated neck portion 30′ using any method appreciated by one of skill in the art.

In an additional embodiment of the present invention, as illustrated in FIG. 5, an elongated neck portion 30″ includes a similar “D-shaped” cross-section form, as in the embodiment of FIGS. 3-4 above. Unlike the embodiments of the elongated neck portions 30,30′ illustrated in FIGS. 3-4, in which the physical indicator 56,56′ takes a ridge-shape form extending outward from the surface of the back side of the elongated neck portion 30,30″, the elongated neck portion 30″ includes a physical indicator 56″ which is a valley extending into the back side 60″ of the elongated neck portion 30″. As with the ridge-shaped physical indicators, the valley-shaped physical indicators may extend only a portion of the distance around the back side 60″ of the elongated neck portion 30″.

FIGS. 6-7 illustrates an exemplary embodiment of a system 10′″ for indicating one or more selective non-consecutive regions for an electric guitar 26′″ having similar properties to the acoustic guitar 26 discussed in the previous embodiments of FIGS. 1-5, but including an elongated neck portion 30′″ with selective non-consecutive regions 12″′, 14′″, 16′″, 20′″, 22′″, 24′″ (i.e. 3^{rd}, 5^{th}, 7^{th}, 9^{th}, 12^{th}, 15^{th}, 17^{th} regions). The physical indicators 56′″, 58′″ illustrated in FIGS. 6-7 are respectively positioned adjacent to the 3^{rd} and 5^{th} fret regions 12′″, 14′″, while another physical indicator 59′″ is positioned adjacent to the 17^{th} fret region 24′″. Those elements of the system 10′″ not discussed are similar to those elements of the previous embodiments of the present invention discussed above, with triple-prime notation, and require no further discussion herein.

FIG. 8 illustrates an exemplary embodiment of a method 100 for indicating one or more selective non-consecutive regions 12,14,16,18,20,22, 24 of a musical instrument 26, such as an acoustic guitar, for example. The method 100 begins (block 101) by positioning (block 102) the plurality of physical indicators 56,58 along the back side 60 of the elongated neck portion 30 opposite to the front side 34. Additionally, the method 100 includes positioning (block 104) the physical indicators 56,58 along the back side 60 adjacent to one or more of the plurality of fret regions 12,14. Additionally, the method 100 includes providing (block 106) non-visual sensory confirmation of the position of the plurality of fret regions along the elongated neck portion 30, before ending at block 107.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed:

1. A system for indicating at least one selective region of a musical instrument, said musical instrument comprising a main body portion, an elongated neck portion extending from the main body portion, and a plurality of strings extending along a front side of said elongated neck portion from an anchor point positioned adjacent to a first end of said elongated neck portion attached to said main body portion, said plurality of strings configured to extend along said elongated neck portion to a respective plurality of tightening devices positioned at a second end of said elongated neck portion opposite from said first end, said elongated neck portion comprising a plurality of spaced-apart boundaries configured to define a plurality of regions along said elongated neck portion, said system comprising:
at least one physical indicator positioned along a back side of said elongated neck portion opposite to said front side, said at least one physical indicator being positioned along said back side adjacent to at least one of said plurality of regions;
said at least one physical indicator being configured to provide non-visual sensory confirmation of the position of said plurality of regions along the elongated neck portion.

2. The system of claim 1, wherein said at least one physical indicator extends outward from the surface of said back side of said elongated neck portion.

3. The system of claim 1, wherein said at least one physical indicator extends into the surface of said back side of said elongated neck portion.

4. The system of claim 1, wherein said at least one physical indicator extends from a top portion to a bottom portion of said back side.

5. The system of claim 1, wherein said non-visual sensory confirmation is configured to assist an individual with a visual disability to confirm the position of said plurality of regions along the elongated neck portion.

6. The system of claim 1, wherein a plurality of physical indicators are positioned adjacent to a plurality of regions along the elongated neck portion, said plurality of physical indicators being positioned adjacent to a respective plurality of selective non-consecutive regions.

7. The system of claim 6, wherein the musical instrument is a guitar, and said plurality of selective non-consecutive regions include a third, fifth, seventh, ninth, twelfth, and fifteenth regions, counted from the first end to the second end of said elongated neck portion.

8. The system of claim 7, wherein the musical instrument is an electric guitar, and said plurality of selective non-consecutive regions further includes a seventeenth region, counted from the first end to the second end of said elongated neck portion.

9. The system of claim 7, wherein the front side of said elongated neck portion is a flat surface, the back side of said elongated neck portion is an arcuate surface.

10. The system of claim 9, wherein said plurality of physical indicators are integrated into the back side of the elongated neck portion.

11. The system of claim 9, wherein said plurality of physical indicators are non-integrated and separately attached to the back side of the elongated neck portion.

12. A system for indicating at least one selective region of a musical instrument, said musical instrument comprising a main body portion, and an elongated neck portion extending from the main body portion, said elongated neck portion comprising a plurality of spaced-apart boundaries configured to define a plurality of regions along said elongated neck portion, said system comprising:
at least one physical indicator positioned along said elongated neck portion adjacent to at least one of said plurality of regions;
said at least one physical indicator being configured to provide non-visual sensory confirmation of the position of said plurality of regions along the elongated neck portion.

13. The system of claim 12, wherein said at least one physical indicator extends outward from the surface of a back side of said elongated neck portion.

14. The system of claim 12, wherein said at least one physical indicator extends into the surface of a back side of said elongated neck portion.

15. The system of claim 12, wherein said at least one physical indicator extends from a top portion to a bottom portion of a back side of said elongated neck portion.

16. The system of claim 12, wherein said non-visual sensory confirmation is configured to assist an individual with a visual disability to confirm the position of said plurality of regions along the elongated neck portion.

17. A method for indicating at least one selective region of a musical instrument, said musical instrument comprising a main body portion, an elongated neck portion extending from the main body portion, and a plurality of strings extending along a front side of said elongated neck portion from a first end of said elongated neck portion attached to said main body portion, said plurality of strings configured to extend along said elongated neck portion to a respective plurality of tightening devices positioned at a second end of said elongated neck portion opposite from said first end, said elongated neck portion comprising a plurality of spaced-apart boundaries configured to define a plurality of regions along said elongated neck portion, said method comprising:
positioning at least one physical indicator along a back side of said elongated neck portion opposite to said front side;
positioning said at least one physical indicator along said back side adjacent to at least one of said plurality of regions; and
providing non-visual sensory confirmation of the position of said plurality of regions along the elongated neck portion.

18. The method of claim 17, further comprising extending said at least one physical indicator outward from the surface of said back side of said elongated neck portion.

19. The method of claim 17, further comprising extending said at least one physical indicator into the surface of said back side of said elongated neck portion.

20. The method of claim 17, wherein said at least one physical indicator extends from a top portion to a bottom portion of said back side.

21. The method of claim 17, further comprising assisting an individual with a visual disability to confirm the position of said plurality of regions along the elongated neck portion.
